(19) United States
(12) Patent Application Publication
(10) Pub. No.: US 2011/0023097 A1
(43) Pub. Date: Jan. 27, 2011

(54) AUTHENTICATION METHOD AND FRAMEWORK

(75) Inventors: Alisdair McDiarmid, Glasgow (GB); James Irvine, Glasgow (GB)

Correspondence Address: PEPPER HAMILTON LLP, ONE MELLON CENTER, 50TH FLOOR, 500 GRANT STREET, PITTSBURGH, PA, 15219, US

(73) Assignee: ITI SCOTLAND LIMITED, Glasgow (GB)

(21) Appl. No.: 12/680,157

(22) PCT Filed: Oct. 6, 2008
(86) PCT No.: PCT/GB2008/003383

§ 371 Date: Oct. 11, 2010

(30) Foreign Application Priority Data
Oct. 5, 2007 (GB) 0719584.5

(51) Int. Cl. H04L 29/06

(52) U.S. Cl. 726/5; 726/3

(57) ABSTRACT

Authentication in an ad-hoc network is established between a first device (for example a service-requesting device) and a second device (for example a service-providing device) using a third device (a peer device). An authentication request is transmitted from the first device to the second device. The second device transmits a query message to at least one third device (i.e. peer device). If the peer device has previously been authenticated with the first device, the peer device sends an authentication credential, for example an authentication key, to the first and second devices. Upon receiving the authentication credential, the first device sends the authentication credential to the second device. The second device then compares the authentication credential received from the first device with the authentication credential received from the third device, and authenticates the first device with the second device if the authentication credentials match. Preferably the authentication credential from the third (peer) device to the first device is encrypted.

### FIELD OF THE INVENTION

The invention relates to an authentication method and framework, and in particular to a peer-to-peer distributed authentication framework and method in a wireless communications network such as an Ultra Wideband communications network.

### BACKGROUND TO THE INVENTION

Ultra-wideband is a radio technology that transmits digital data across a very wide frequency range, 3.1 to 10.6 GHz. By spreading the RF energy across a large bandwidth the transmitted signal is virtually undetectable by traditional frequency selective RF technologies. However, the low transmission power limits the communication distances to typically less than 10 to 15 meters.

There are two approaches to UWB: the time-domain approach, which constructs a signal from pulse waveforms with UWB properties, and a frequency-domain modulation approach using conventional FFT-based Orthogonal Frequency Division Multiplexing (OFDM) over Multiple (frequency) Bands, giving MB-OFDM. Both UWB approaches give rise to spectral components covering a very wide bandwidth in the frequency spectrum, hence the term ultra-wideband, whereby the bandwidth occupies more than 20 percent of the centre frequency, typically at least 500 MHz.

These properties of ultra-wideband, coupled with the very wide bandwidth, mean that UWB is an ideal technology for providing high-speed wireless communication in the home or office environment, whereby the communicating devices are within a range of 10-15 m of one another.

FIG. 1 shows the arrangement of frequency bands in a Multi Band Orthogonal Frequency Division Multiplexing (MB-OFDM) system for ultra-wideband communication. The MB-OFDM system comprises fourteen sub-bands of 528 MHz each, and uses frequency hopping every 312.5 ns between sub-bands as an access method. Within each sub-band OFDM and QPSK or DCM coding is employed to transmit data. It is noted that the sub-band around 5 GHz, currently 5.1-5.8 GHz, is left blank to avoid interference with existing narrowband systems, for example 802.11a WLAN systems, security agency communication systems, or the aviation industry.

The fourteen sub-bands are organised into five band groups, four having three 528 MHz sub-bands, and one band group having two 528 MHz sub-bands. As shown in FIG. 1, the first band group comprises sub-band 1, sub-band 2 and sub-band 3. An example UWB system will employ frequency hopping between sub-bands of a band group, such that a first data symbol is transmitted in a first 312.5 ns duration time interval in a first frequency sub-band of a band group, a second data symbol is transmitted in a second 312.5 ns duration time interval in a second frequency sub-band of a band group, and a third data symbol is transmitted in a third 312.5 ns duration time interval in a third frequency sub-band of the band group. Therefore, during each time interval a data symbol is transmitted in a respective sub-band having a bandwidth of 528 MHz, for example sub-band 2 having a 528 MHz baseband signal centred at 3960 MHz.

A sequence of three frequencies on which each data symbol is sent represents a Time Frequency Code (TFC) channel. A first TFC channel can follow the sequence 1, 2, 3, 1, 2, 3 where 1 is the first sub-band, 2 is the second sub-band and 3 is the third sub-band. Second and third TFC channels can follow the sequences 1, 3, 2, 1, 3, 2 and 1, 1, 2, 2, 3, 3 respectively. In accordance with the ECMA-368 specification, seven TFC channels are defined for each of the first four band groups, with two TFC channels being defined for the fifth band group.

The technical properties of ultra-wideband mean that it is being deployed for applications in the field of data communications. For example, a wide variety of applications exist that focus on cable replacement in the following environments:
communication between PCs and peripherals, i.e. external devices such as hard disc drives, CD writers, printers, scanner, etc.
home entertainment, such as televisions and devices that connect by wireless means, wireless speakers, etc.
communication between handheld devices and PCs, for example mobile phones and PDAs, digital cameras and MP3 players, etc.

In wireless networks such as UWB networks one or more devices periodically transmit a Beacon frame during a Beacon Period. The main purpose of the Beacon frame is to provide for a timing structure on the medium, i.e. the division of time into so-called superframes, and to allow the devices of the network to synchronize with their neighbouring devices.

The basic timing structure of a UWB system is a superframe as shown in FIG. 2. A superframe according to the European Computer Manufacturers Association standard (ECMA), ECMA-368 2^{nd} Edition, consists of 256 medium access slots (MAS), where each MAS has a defined duration e.g. 256 μs. Each superframe starts with a Beacon Period, which lasts one or more contiguous MAS's. Each MAS forming the Beacon Period comprises three Beacon slots, with devices transmitting their respective Beacon frames in a Beacon slot. The start of the first MAS in the Beacon Period is known as the Beacon Period Start Time (BPST). A Beacon group for a particular device is defined as the group of devices that have a shared Beacon Period Start Time (±1 μs) with the particular device, and which are in transmission range of the particular device.

Wireless systems such as the UWB system described above are increasingly being used in an ad-hoc peer-to-peer configuration. This means that the network will exist without central control or organisation, with each device potentially communicating with all others within range. There are several advantages to this approach, such as spontaneity and flexible interactions. However, such a flexible arrangement also raises other problems which need to be solved.

For example, since there is no overseeing authority, the individual devices or users in the network must fulfil the role otherwise held by such an authority. For many tasks, this can be achieved by each device independently, but some tasks cannot work this way. It is particularly important to note that traditional centralised authentication architectures cannot function in an ad-hoc network. This is because no peer can be trusted to operate as the central security server.

Authentication is the process of proving and verifying the “identity” of a device or user, and is required to counter impersonation attacks. FIG. 3 shows a traditional approach for providing authentication in a network 2 having a plurality of individual devices or users 4 (labelled A to C). Authentication according to this traditional approach is carried out by storing a list of identities (for example usernames and passwords) in a memory 5 of a central authentication server “D” (for example a web server application such as Apache, or a login server on UNIX), along with credentials which the owner of each identity also holds. Then, any user “A” who wishes to prove their identity to another user “B” can provide these credentials to the authentication server D, which then informs “B” of the validity of their credentials. If “A” and “B” both trust “D”, which is very likely if D is run by the controller of the network, then this approach is a very simple and effective method of providing authentication. These systems require the service-providing device to perform authentication for each user and authorisation for each request.

Since an ad-hoc peer-to-peer network has no single trusted server such as D, this role cannot be fulfilled. Furthermore, this requires several lists of authentication credentials, which implies that a setup phase must be completed before using each service. Pre-sharing credentials in this way is appropriate for long-term usage, but not useful in an ad-hoc situation.

Other solutions to device authentication, for example during network access, is to share a single key or password (for example, IEEE 802.11's WPA-PSK, as described by the Wi-Fi Alliance in a paper entitled “Wi-Fi Protected Access: Strong, standards-based, interoperable security for today's Wi-Fi networks”, 2003).

A commonly-used distributed authentication protocol framework for use in wireless networks is Extensible Authentication Protocol (EAP), as described in a paper by Aboba et al. entitled “Extensible Authentication Protocol (EAP)”, RFC 3748, IETF Network Working Group, June 2004. The meaning of “distributed” in this context means that the authentication server may be on a different network from the service-providing device and the unauthenticated user. EAP is therefore also effectively centralised, and its main advantage is in having one authentication server usable from multiple locations. In other words, this second known approach is similar to that described above, but centralises the authentication information. This has the advantage of reducing the number of independent lists of credentials, meaning that only one setup phase must be completed for each user device. However, an ad-hoc peer-to-peer network by definition can have no central, trusted authentication server.

It is therefore an aim of the present invention to provide an authentication method and framework that can be used in an ad-hoc peer-to-peer network.

### SUMMARY OF THE INVENTION

According to a first aspect of the invention, there is provided a method of authenticating a first device with a second device in a communications network, the method comprising the steps of using a third device in the authentication process, the third device having an existing secure authentication with each of the respective first and second devices.

The authentication method defined in claim 1 below overcomes the disadvantages of authentication in an ad-hoc peer-to-peer network by distributing the authority across the entire network. In this way, no single entity need be trusted for the authentication process. Furthermore, more flexible authentication can be achieved using this invention than the traditional approach, due to the increased amount of information available from devices or users of the network.

### BRIEF DESCRIPTION OF THE DRAWINGS

For a better understanding of the present invention, and to show more clearly how it may be put into effect, reference will now be made, by way of example only, to the following drawings, in which:

FIG. 1 shows the arrangement of frequency bands in a Multi-Band Orthogonal Frequency Division Multiplexing (MB-OFDM) system for ultra-wideband communication;

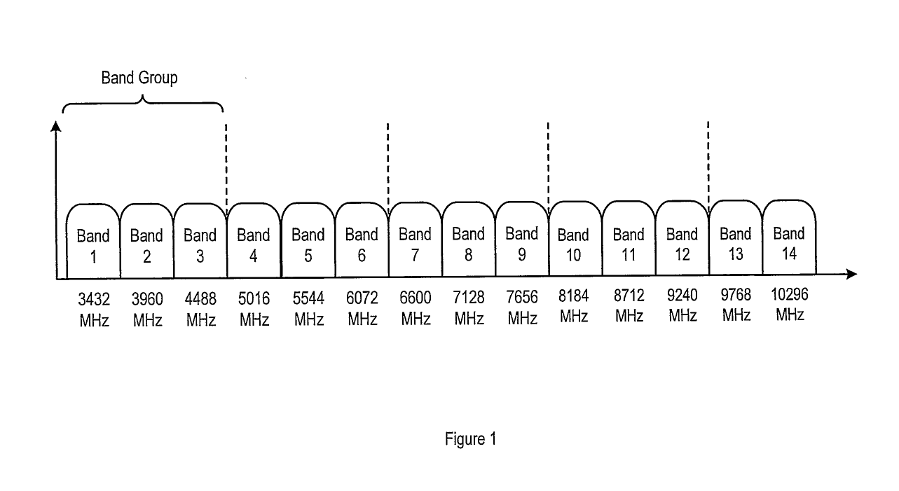

FIG. 2 shows the basic timing structure of a superframe in a UWB system;

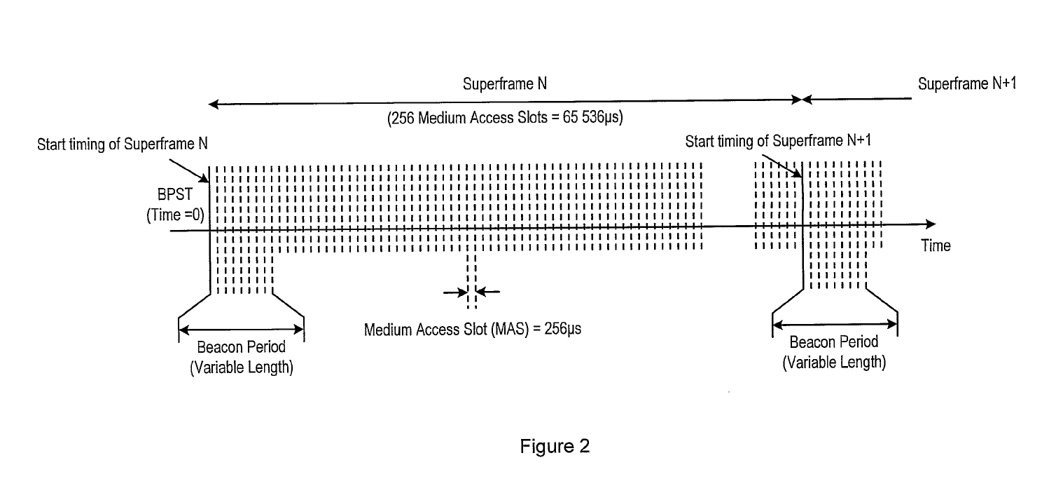

FIG. 3 illustrates a traditional network;

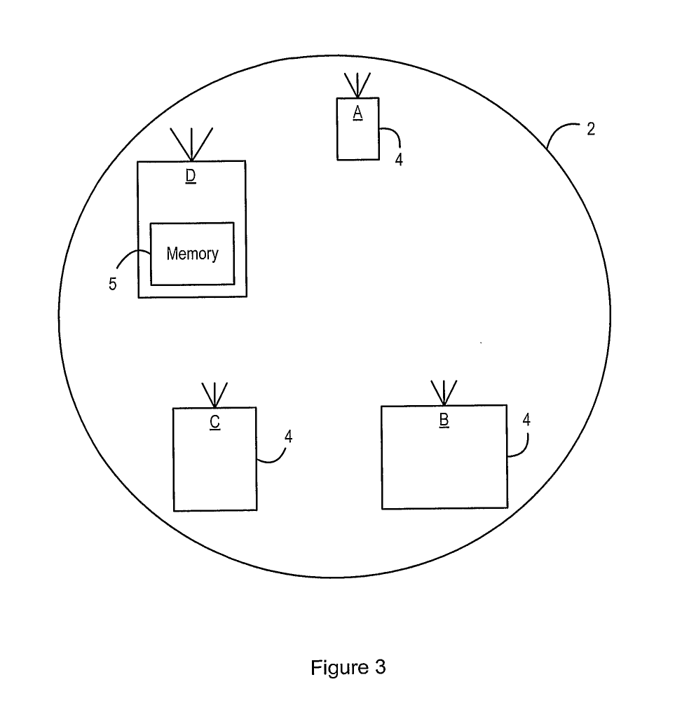

FIG. 4 shows the authentication framework according to the present invention;

FIG. 5 shows the steps performed in the service-providing device of the network;

FIG. 6 shows the steps performed in the service-requesting device of the network;

FIG. 7 shows the steps performed in the peer device of the network.

### DETAILED DESCRIPTION OF A PREFERRED EMBODIMENT OF THE INVENTION

The invention will be described hereinafter with reference to an Ultra Wideband wireless communications network. However, it will be appreciated that the invention is also applicable to other communications networks.

The invention will also be described in relation to an unauthenticated device in the form of a service-requesting device, and a secure or authenticated device in the form of a service-providing device. However, it will be appreciated that the invention is applicable to any form of device.

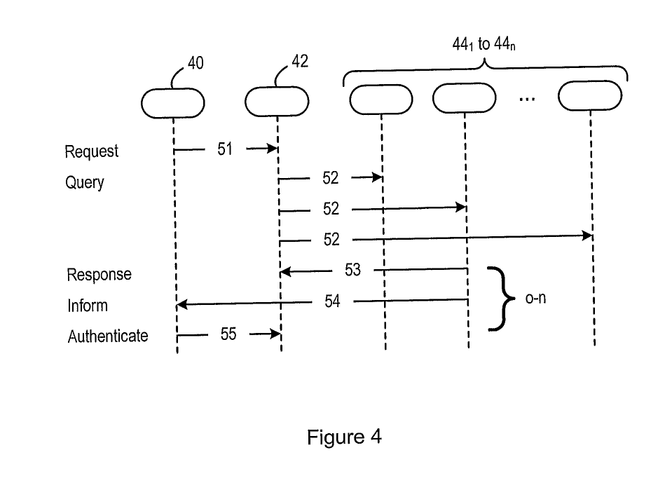

FIG. 4 shows the protocol framework for enabling an unauthenticated user 40 (for example a service-requesting device) to be authenticated with another device 42 (for example a service-providing device). According to the invention, a multi stage protocol is used to securely retrieve authentication-related information from one or more other devices 44₁ to 44ₙ within the network. This allows a service-providing device 42 to verify the identity of a service-requesting device 40, in order to determine whether or not to proceed in offering the service.

FIG. 4 shows that there are five steps 51 to 55 in the general protocol framework. In chronological order, these are “51—request”, “52—query”, “53—response”, “54—inform”, and “55—authenticate”. The purpose of each of these steps will be described in greater detail below. It is noted, however, that protocols generated from this framework need not be restricted to these particular steps, and that additional messages before or after the framework steps may be required for some applications, or fewer steps for other applications. It is also noted that these message flows are not necessarily at layer 2 (for example a data link layer in an OSI model), and any device may be communicating with another through a multi-hop network.

The protocol is initiated when the unauthenticated device, such as a service-requesting device 40, sends a service request to a secure device, such as a service-providing device 42. If the service-requesting device 40 is unauthenticated, the service-providing device 42 sends a query message 52 to one or more of its peers 44₁ to 44ₙ. According to one embodiment, the service-providing device 42 sends a query message to all of its peers 44₁ to 44ₙ. The query message 52 contains a unique identifier corresponding to the unauthenticated device 40, which is used as an address. It is noted that a peer device 44 is a device that has been authenticated with the service-providing device 42, and either has a current authentication or has been previously authenticated with the service-providing device 42.

Any peer device 44 which receives the query message 52, and which has a secure association with the unauthenticated device 40, then sends two messages. The first message is a response message 53 to the service-providing device 42. The second message is an inform message 54 to the unauthenticated device 40. Both the response message 53 and the inform message 54 contain an authentication credential “R”. For example, the authentication credential “R” may be an authentication key, or any other form of authentication data. According to one example, the authentication credential “R” is a randomly-generated authentication key.

Since the unauthenticated device 40 and the peer device 44 have an existing secure association, the peer device 44 can send the inform message 54 in an encrypted format so that only the true unauthenticated device 40 is able to read the inform message 40. The unauthenticated device 40, having decrypted the authentication credential “R”, sends an authentication message 55 to the service-providing device 42.

On receipt of the authentication message 55 from the service-requesting device 40, the service providing device 42 compares the authentication credential “R” with the authentication credential received from the peer device 44 in the response message 53. If the authentication credential received in the authentication message 55 matches the authentication credential received in the response message 53, the authentication message 55 is validated, such that services can be provided.

It will be appreciated that, since only the true service-requesting device 40 can send the authentication message 55 to the service-providing device 42, this prevents impersonation and allows authentication to take place.

In the embodiment described above the authentication decision is made by the service-providing device 42 based on a response message 53 received from a single peer 44. According to another aspect of the invention, the authentication decision may be based on multiple response messages 53 received from multiple peer devices 44, each having a respective authentication credential. In this situation the service-providing device 42 will also receive corresponding multiple authentication credentials from the service requesting device 40. The multiple authentication credentials may be the same or different.

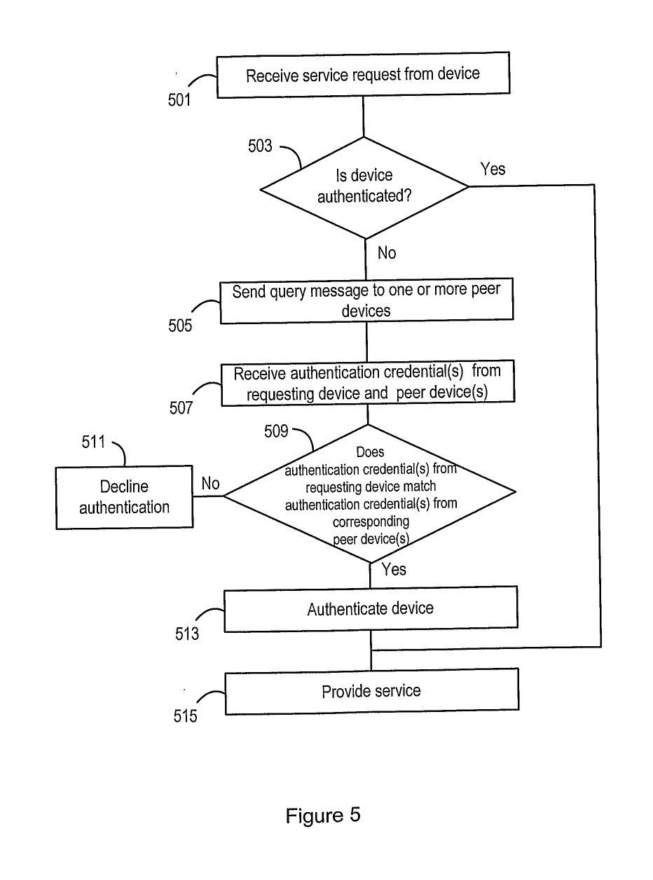

FIG. 5 is a flow chart describing the steps performed in a secure device when receiving a request from an unauthenticated device, for example in order to provide service to an unauthenticated service-requesting device. After receiving a service request in step 501, the device determines whether the service requesting device is already authenticated, step 503. If the service-requesting device is already authenticated, the service-providing device provides the required service in step 515.

However, if it is determined in step 503 that the service-requesting device is not already authenticated, the service-providing device sends a query message to one or more of its peer device, step 505. The service-providing device then receives at least one authentication credential from the service-requesting device and at least one corresponding authentication credential from a peer device, step 507. In step 509 the service-providing device determines if the authentication credential received from the service-requesting device matches the authentication credential received from the corresponding peer device. If the authentication credentials match, the service-providing device authenticates the service-requesting device, step 513, and provides the required service, step 515.

If the authentication credential received from the service-requesting device does not match the authentication credential received from a peer device, authentication of the service-requesting device is declined, step 511.

It will be appreciated from the above that a device receiving a request for authentication from another device queries one or more of its peers for information about the unauthenticated device. Some of those peers respond to both the service-providing device and the unauthenticated device, and the unauthenticated device contacts the service-providing device to demonstrate its identity.

As mentioned above, the authentication step 509 can be configured to take place based on an authentication credential received from just one peer device, or multiple authentication credentials received from a plurality of peer devices. Thus, according to the latter, the unauthenticated device must have an existing secure authentication with two or more peer devices of the service-providing device before authentication is allowed.

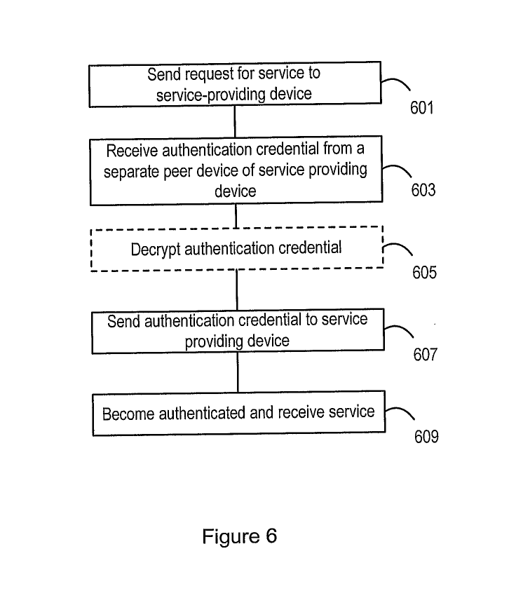

FIG. 6 is a flow chart describing the steps performed in an unauthenticated device, when attempting to become authenticated with a secure device. In step 601 the unauthenticated device sends a request for service to a service-providing device.

Next, the unauthenticated device receives an authentication credential from a separate peer device, step 603. If the received authentication credential is in an encrypted format, the unauthenticated device then decrypts the authentication credential, step 605, before sending the authentication credential to the service-providing device, step 607. The service-providing device will have received its own version of the authentication credential from the peer device and, providing that the authentication credentials match, the unauthenticated device becomes authenticated and receives service from the service-providing device, step 609.

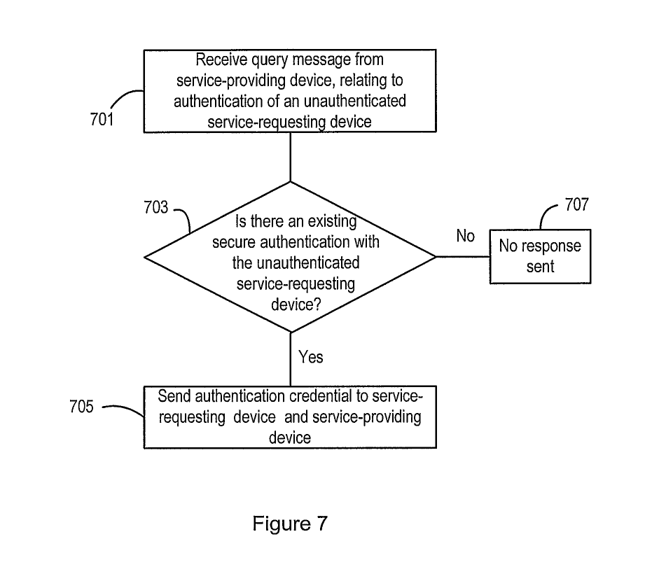

FIG. 7 is a flow chart describing the steps performed in a peer device, when taking part in an authentication process between a service-providing device and a service-requesting device that is unauthenticated with the service-providing device. In step 701 the peer device receives a query from a service-providing device, the query containing the address of the unauthenticated service-requesting device.

In step 703 the peer device determines whether the unauthenticated service-requesting device is authenticated with the peer device. Preferably this involves determining whether the unauthenticated service-requesting device is currently authenticated with the peer device. As an alternative to determining whether the service-requesting device is currently authenticated with the peer device, step 703 may involve determining whether the service-requesting device has previously been authenticated with the peer device, possibly within a predetermined time period.

If the peer device is authenticated with the service-requesting device, then the peer device sends an authentication credential to both the service-requesting device and the service-providing device, step 705. According to one embodiment, the peer device encrypts the authentication credential sent to the unauthenticated device. The encryption is carried out based on the authentication set-up between the peer device and the unauthenticated device.

If in step 703 it is determined that the peer device has no secure authentication with the service-requesting device, then no response is sent, step 707. Alternatively, the peer device may be configured to send a response to only the service-providing device, indicating that the peer device has no authentication with the service-requesting device.

The invention described above solves the authentication problem in ad-hoc networks by distributing the authority across the entire network. In this way, no single entity need be trusted for the authentication process. Furthermore, more flexible authentication can be achieved using this invention than the traditional approach, due to the increased amount of information available from devices or users of the network.

It is noted that the protocol framework described above can operate at the application layer, and does not require any lower level extensions or modifications.

The invention has the advantage of not requiring any central authentication server, thereby simplifying network management. Instead, latent authentication information can be retrieved from a network of peers, while the authentication protocol ensures that impersonation is not possible.

The invention also has the advantage that there is no need for any direct user interaction after the service is requested. Services can be authenticated, simply and easily with no user interaction necessary.

The invention allows the service-providing device to retrieve authentication information from the ad-hoc network as and when it is needed. This demands no setup phase, requires no centralised trusted server, and no long-term central list of credentials need be gathered.

1. A method of authenticating a first device with a second device in a communications network, the method comprising the steps of using a third device in the authentication process, the third device having a secure authentication with each of the respective first and second devices.

2. A method as claimed in claim 1, further comprising the steps of:
sending a query message from the second device to the third device in response to the second device receiving an authentication request from the first device; and
the third device providing information to assist the second device in determining whether to authenticate the first device.

3. A method as claimed in claim 2, wherein the query message includes the identity of the first device.

4. A method as claimed in claim 2, wherein the step of providing information comprises the step of
transmitting an authentication credential from the third device to the first device and the second device.

5. A method as claimed in claim 4, further comprising the steps of transmitting the authentication credential received at the first device to the second device;
comparing, at the second device, the authentication credential received from the first device with the authentication credential received from the third device; and
authenticating the first device with the second device if the authentication credential from the first device matches the authentication credential from the second device.

6. A method as claimed in claim 4, further comprising the steps of:
encrypting the authentication credential sent from the third device to the first device; and
decrypting the authentication credential at the first device prior to transmitting the authentication credential from the first device to the second device.

7. A method as claimed in claim 1, further comprising the steps of using a fourth device in the authentication process, the fourth device having a secure authentication with each of the respective first and second devices.

8. A method as claimed in claim 7, further comprising the steps of:
transmitting a second authentication credential from the fourth device to the first device and the second device;
transmitting the second authentication credential received at the first device to the second device; and
comparing, at the second device, the second authentication credential received from the first device with the second authentication credential received from the third device, and authenticating the first device with the second device if the authentication credentials match.

9. A method as claimed in claim 4, further comprising the step of randomly generating the authentication credential.

10. A method as claimed in claim 9, wherein the authentication credential is an authentication key.

11. A method as claimed in claim 1, wherein the secure authentication between the third device and the first device is based on the third device and first device being currently authenticated.

12. A method as claimed in claim 1, wherein the secure authentication between the third device and the first device is based on the third device and first device having been previously authenticated.

13. A method as claimed in claim 12, wherein the third device and the first device have been previously authenticated within a predetermined time period.

14. A method of performing authentication at a service-providing device, the method comprising the steps of:
receiving an authentication request from a service-requesting device;
transmitting a query message to one or more peer devices authenticated with the service-providing device;
receiving an authentication credential from a peer device;
receiving an authentication credential from the service-requesting device; and
authenticating the service-requesting device if the authentication credential from the peer device matches the authentication credential from the service-requesting device.

15. A method of obtaining authentication in a service-requesting device, the method comprising the steps of:
transmitting an authentication request to a service-providing device;
receiving an authentication credential from a peer device authenticated with the service-providing device; and
transmitting the received authentication credential to the service-providing device, such that the service-providing device can perform an authentication decision.

16. A method of performing authentication in a peer device, the peer device used for assisting with the authentication between a service-requesting device and a service-providing device, the method comprising the steps of:
receiving a query message from the service-providing device, wherein the service-providing device is authenticated with the peer device, and wherein the query message contains the identity of the service-requesting device;
determining whether the peer device is authenticated with the service-requesting device and, if so:
transmitting an authentication credential to the service-providing device; and
transmitting the authentication credential to the service-requesting device.

17. A method as claimed in claim 14, wherein the authentication credential is an authentication key.

18. A communications network configured to provide authentication between a first device and a second device in the communications network, wherein the network is adapted to use a third device in the authentication process, the third device having a secure authentication with each of the respective first and second devices.

19. A network as claimed in claim 18, wherein the network is further configured to:
transmit an authentication request from the first device to the second device;
transmit a query message from the second device to the third device;
transmit an authentication credential from the third device to the first device and the second device;
transmit the authentication credential received at the first device to the second device; and
compare, at the second device, the authentication credential received from the first device with the authentication credential received from the third device, and authenticate the first device with the second device if the authentication credential from the first device matches the authentication credential from the third device.

20. A network as claimed in claim 19, wherein the query message transmitted from the second device to the third device comprises the identity of the first device.

21. A network as claimed in claim 19, wherein the authentication credential sent from the third device to the first device is encrypted, and wherein the authentication credential is decrypted at the first device prior to the authentication credential being transmitted from the first device to the second device.

22. A network as claimed in claim 18, wherein the network is further adapted to use a fourth device in the authentication process, the fourth device having a secure authentication with each of the respective first and second devices.

23. A network as claimed in claim 22, wherein the network is further adapted to:
transmit a second authentication credential from the fourth device to the first device and the second device;
transmit the second authentication credential received at the first device to the second device; and
compare, at the second device, the second authentication credential received from the first device with the second authentication credential received from the third device, and authenticate the first device with the second device if the second authentication credentials match.

24. A network as claimed in claim 19, wherein the authentication credential is randomly generated.

25. A network as claimed in claim 24, wherein the authentication credential is an authentication key.

26. A device for use in authenticating an unauthenticated device, the device comprising a transceiver adapted to:
receive an authentication request from the unauthenticated device;
transmit a query message to one or more peer devices currently authenticated with the device;
receive an authentication credential from a peer device;
receive an authentication credential from the unauthenticated device; and
authenticate the unauthenticated device if the authentication credential received from the unauthenticated device matches the authentication credential received from the peer device.

27. A device comprising:
means for transmitting an authentication request to a second device;
means for receiving an authentication credential from one or more peer devices currently authenticated with the second device; and
means for transmitting the received authentication credential to the second device.

28. A device for use in authenticating a first device with a second device, the device being authenticated with the second device, the device comprising a transceiver adapted to;
receive a query message from the second device, the query message containing the identity of the first device;
determine whether the device has authenticated with the first device and, if so:
transmit an authentication credential to the first device; and
transmit the authentication credential to the second device.

29. A device as claimed in claim 26, wherein the authentication credential is an authentication key.

30. A method as claimed in claim 15, wherein the authentication credential is an authentication key.

31. A method as claimed in claim 16, wherein the authentication credential is an authentication key.

32. A device as claimed in claim 27, wherein the authentication credential is an authentication key.

33. A device as claimed in claim 28, wherein the authentication credential is an authentication key.
